(19) United States
(12) Patent Application Publication
(10) Pub. No.: US 2016/0046301 A1
(43) Pub. Date: Feb. 18, 2016

(54) APPARATUS FOR CONTROLLING A DRIVE DEVICE IN A RAIL VEHICLE

(71) Applicant: SIEMENS AKTIENGESELLSCHAFT, München (DE)

(72) Inventor: MANFRED WIESAND, BURGTHANN (DE)

(21) Appl. No.: 14/779,090

(22) PCT Filed: Mar. 25, 2014
(86) PCT No.: PCT/EP2014/055944

§ 371 Date: Sep. 22, 2015

(30) Foreign Application Priority Data
Mar. 28, 2013 (DE) 10 2013 205 698.2

(51) Int. Cl. B61C 3/00; B61H 13/00; G05B 15/02

(52) U.S. Cl. CPC B61C 3/00; G05B 15/02; B61H 13/00; Y10S 903/902

(57) ABSTRACT

An apparatus for controlling a drive device in a rail vehicle includes a computer unit and a memory unit for storing at least one module of a drive control program. The module is provided for at least one drive control function to be carried out by the computer unit. In order to provide an apparatus of this generic type, by way of which a low level of outlay on construction in respect of implementing control functions can be achieved, the memory unit is used to store at least one module of a brake control program. The module is configured so that at least one brake control function for a brake device of the rail vehicle is carried out by the computer unit.

The invention relates to an apparatus for controlling a drive device in a rail vehicle, having a computer unit and a memory unit for storing at least one module of a drive control program, wherein this module is provided for the purpose of being executed in order for at least one drive control function to be carried out by the computer unit.

The operation of a rail vehicle involves, in particular, control of a drive device which serves to generate a drive torque in a traction mode. Drive control functions are carried out by means of a computer unit which executes corresponding modules of a drive control program. When the drive device is formed with electric motors and associated traction power converters, a drive control function involves implementing a switching strategy of the power converter valves for generating an electrical power for the electric motors.

In addition to implementing drive control, the operation of the rail vehicle comprises further aspects with which further control tasks are associated.

The invention is based on the object of providing an apparatus of this generic type by way of which a low level of structural expenditure in respect of implementation of control functions can be achieved.

To this end, it is proposed that the memory unit serves to store at least one module of a brake control program, wherein this module is provided for the purpose of being executed in order for at least one brake control function for a brake device of the rail vehicle to be carried out by the computer unit. As a result, a particularly low level of structural expenditure in respect of implementation of drive and brake control tasks in the rail vehicle can be achieved. Owing to at least one driver control function and at least one brake control function being executed by a common computer unit, installation space, costs and weight can be saved when constructing the rail vehicle. The level of energy consumption can also be reduced.

A “module” of a drive or brake control program is intended to be understood to mean, in particular, at least a constituent part of the drive or brake control program which serves to carry out a specific function of the drive or brake control means. The module of the drive control program is preferably provided for the purpose of being executed in order for at least one drive control function to be carried out by the computer unit in a traction mode of the rail vehicle. In this traction mode, the drive device is controlled in such a way that it serves to generate a drive torque. The drive and/or brake control program can consist of a single module or it can have several modules which are each provided for carrying out a specific function from amongst a large number of control functions.

The apparatus is expediently operatively connected to a unit which outputs command signals for the drive device and/or the brake device, wherein the drive or brake control function is executed on the basis of these command signals. In particular, these command signals can be triggered by manual operation by the rail vehicle driver and/or automatically by a controller of the rail vehicle.

In order to execute the drive and/or brake control function, the apparatus can advantageously be operatively connected to a unit which outputs at least one signal in respect of at least one operating parameter of the rail vehicle. By way of example, the unit can output a signal with which information about the speed, the mass etc. of the rail vehicle can be transmitted as an input signal for the apparatus.

The computer unit is in contrast to an imaginary combination of units which are physically separate from one another and, in particular, distributed over the rail vehicle—expediently a coherent unit which has, in particular, at least one processor unit. In particular, the computer unit can have at least one processor which can be in the form of a single-core processor or in the form of a multi-core processor.

Combined execution of a module of the drive control program and a module of the brake control program by the computer unit can be performed with a high level of computational power when the computer unit is designed for operation with at least two processing units, wherein, in at least one operating phase, a different processor unit is in each case allocated to the module of the drive control program and to the module of the brake control program. If the computer unit has a single-core processor, the processing units are expediently in the form of processing units which can be allocated logically and/or dynamically. In particular, the processor units can be produced from a static or dynamic distribution of the processor resources for the modules which are to be executed. If the computer unit has a multi-core processor, the processor units are expediently formed by a different processor core in each case.

If the brake device of the rail vehicle is in the form of a device which is controlled by compressed air, a high-priority and comprehensive control task of a brake control device can be executed by the computer unit when the module of the brake control program is provided for executing a compressed-air brake valve control function. In this case, the apparatus according to the invention is expediently operatively connected to at least one valve device of the brake device, said valve device serving to control the pressure of compressed air which serves to operate brake elements of the brake device.

A further highly important control task of a brake device can be executed by the computer unit when the module of the brake control program is provided for executing a sliding-prevention function. To this end, the apparatus according to the invention is expediently operatively connected to a sensor unit which serves to monitor at least one axle of the rail vehicle, which axle is to be protected, or to detect at least one characteristic variable which relates to this axle. The sliding-prevention function which is executed by the computer unit can involve evaluating this characteristic variable and an operating parameter of the rail vehicle which is received by means of an input signal, in particular the vehicle speed, and possibly initiating a measure by means of the brake device.

If the drive device is equipped with at least an electric motor and a traction power converter for supplying the electric motor, a high-priority and comprehensive control task of a drive control device can be executed by the computer unit when the module of the drive control program is provided for executing a traction power converter control function. A drive control function which is carried out by the module of the drive control program, in particular in a traction mode of the rail vehicle, can preferably involve implementing a switching strategy of the power converter valves for generating electrical power for the at least one electric motor in this case.

The computer unit and the at least one constituent part of the memory unit can be accommodated in different, separate devices of the rail vehicle. However, a compact design of the apparatus can be achieved if said apparatus has a housing in which the computer unit and the memory unit are arranged.

It is also proposed that the apparatus has a voltage supply device which is provided for supplying housing components. A small installation space can advantageously be achieved by a voltage supply device which is common to the housing components.

In an advantageous development of the invention, it is proposed that the apparatus has a communication module which is provided for the purpose of establishing data communication with a rail vehicle control unit. The communication module advantageously constitutes a communication interface of at least one component of the apparatus, in particular of the computer unit of said apparatus, with a data bus of the rail vehicle, it being possible to transmit data and commands from the rail vehicle control unit to said component via said communication interface.

The invention further proceeds from an apparatus for controlling a drive device in a rail vehicle, in which method at least one drive control function is executed by a computer unit.

It is proposed that the least one brake control function for controlling a brake device of the rail vehicle is executed by the computer unit. In order to avoid unnecessary repetition, reference is made to the above statements in relation to the apparatus according to the invention in respect of the advantageous effects of the method.

An exemplary embodiment of the invention is explained in greater detail with reference to the drawings, in which:

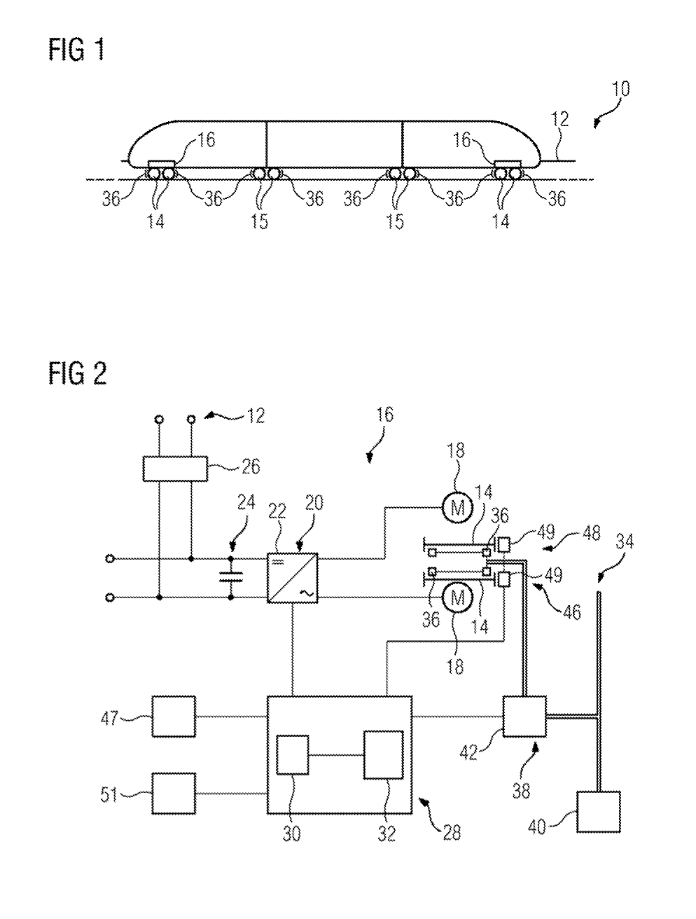

FIG. 1: shows a rail vehicle having drive devices and a brake device,

FIG. 2: shows one of the drive devices and the brake device from FIG. 1 and an apparatus for controlling the drive device and the brake device, and

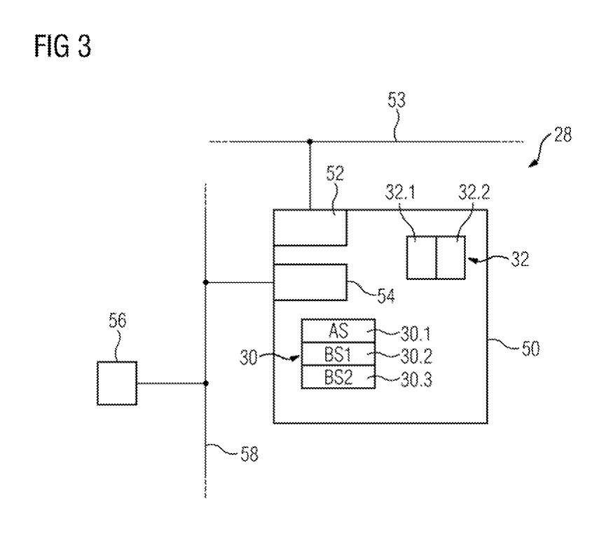

FIG. 3: shows a detailed view of the apparatus from FIG. 2.

FIG. 1 shows a schematic side view of a rail vehicle 10. In the exemplary embodiment under consideration, the rail vehicle 10 is in the form of an electrically driven multiple unit which is operated by a system supply voltage which is tapped off by means of a current collector. In particular, the electrical system supply voltage is tapped off from a system voltage supply 12 which is in the form of a busbar, wherein the system supply voltage is, in particular, a DC voltage.

In a further design, the rail vehicle 10 can be equipped to tap off the system supply voltage from a system voltage supply which is in the form of an overhead line, wherein the system supply voltage can be a DC or AC voltage. Furthermore, the rail vehicle 10 can be equipped with a generator which provides an electrical voltage by means of a fuel-driven motor.

The rail vehicle 10 has drive axles 14 which can be driven by means of drive devices 16, wherein a separate drive device 16 is in each case associated with pairs of drive axles 14 which, in particular, belong to the same truck. In this case, the drive devices 16 in each case have a separate electric motor 18 for each of the associated drive axles 14 (see FIG. 2). In addition, the rail vehicle 10 has non-driven axles—also called running axles 15.

A design of one of the drive devices 16 from FIG. 1 is shown in FIG. 2.

The drive devices 16 have the electric motors 18, which can each be mechanically coupled to a different drive axle 14, and in each case one power supply unit 20 which is provided for the purpose of generating an electrical power for the associated electric motors 18 in a traction mode. The shown power supply unit 20 comprises a traction power converter 22 which is associated with the pair of electric motors 18. In an alternative design, the power supply unit 20 can have a separate traction power converter 22 for each of the electric motors 18 which are associated with it.

In the traction mode, the power supply unit 20 draws electrical energy from a DC voltage intermediate circuit 24. If—as in the design under consideration—the rail vehicle 10 is operated using a DC voltage, the DC voltage intermediate circuit 24 can be fed, as illustrated, directly, that is to say without the interconnection of a voltage converter apparatus, from the voltage input, that is to say from the system voltage supply 12. Further devices, such as a filter device 26 in particular, can be connected between the DC voltage intermediate circuit 24 and the voltage input. If the rail vehicle 10 is operated using an input voltage which is in the form of an AC voltage, a voltage conversion apparatus which comprises a transformer and a rectifier for example and which provides the DC voltage of the DC voltage intermediate circuit 24 from the input voltage is connected between the voltage input and the DC voltage intermediate circuit 24.

The traction power converter 22 has, as is known, switching elements which, according to a specific switching strategy, generate an electric current for feeding the electric motors 18 from the DC voltage of the DC voltage intermediate circuit 24, the characteristics of said electric current being matched to the power which is to be generated. The switching elements are also known by the term “power converter valves” to a person skilled in the art. The power supply unit 20 is controlled by means of an apparatus 28 which is operatively connected to the power supply unit 20 in terms of control. The apparatus 28 serves, in particular, to generate switching commands for the switching elements of the at least one traction power converter 22 according to the switching strategy. At least one module of a drive control program is provided in order to execute this drive control function, in particular this traction power converter control function, for the power supply unit 20, wherein said module is stored in a memory unit 30 and can be executed by a computer unit 32 of the apparatus 28. The apparatus 28 is also known by the term “drive controller” to a person skilled in the art.

The rail vehicle 10 further has a brake device 34 which comprises friction brake elements 36 which are schematically illustrated in FIG. 1. When a braking process is initiated, said friction brake elements are operated by means of a pneumatic operating device 38. To this end, the brake device 34 has, as is known, a compressed-air device 40 which provides compressed air for operating the friction brake elements 36. Friction brake elements 36 are operated by controlling a valve device 42 which is associated with said friction brake elements 36 and form part of the pneumatic operating device 38 and by means of which the pressure of the compressed air which serves to operate the friction brake elements 36 can be controlled.

The drive axles 14 which are associated with the electric motors 18, the friction brake elements 36 which are associated with said drive axles, and the valve device 42 for operating the friction brake elements 36 are illustrated in FIG. 2. The apparatus 28 is provided for the purpose of executing a brake control function, in particular a compressed-air brake valve control function in which the valve device 42 which is associated with the friction brake elements 36 is controlled. To this end, a corresponding module of a brake control program which can be executed by the computer unit 32 is stored in the memory unit 30. When executing the module, the apparatus 28 takes on the function of a device which is known by the term “brake controller” to a person skilled in the art.

The rail vehicle 10 also has a sliding-prevention device 46. Said sliding-prevention device is equipped with a sensor unit 48 which is associated, in particular, with the drive axles 14 which are illustrated in FIG. 2. In the design under consideration, the sensor unit 48 is formed by rotation speed sensors 49. By comparing a characteristic variable which is detected by the sensor unit 48 with an operating parameter of the rail vehicle 10, in particular the vehicle speed, sliding of the axle 14 which is monitored by the sensor unit 48 can be detected during a braking operation, wherein this detection process forms the basis for corresponding countermeasures being initiated by means of the brake device 34. The apparatus 28 is provided for the purpose of executing a sliding-prevention function for the brake device 34. In this case, the brake device 34 is controlled on the basis of at least one characteristic variable which is detected by the sensor unit 48. To this end, the apparatus 28 is operatively connected to the sensor unit 48, and a module of the brake control program which is executed by the control unit 32 in order to execute the sliding-prevention function is stored in the memory unit 30. The apparatus 28 is also operatively connected to an output of a unit 47 which outputs a signal for transmitting information about the operating parameter, in particular the vehicle speed.

The apparatus 28 is further operatively connected to an output of a unit 51 which outputs command signals for the drive device 16 and/for the brake device 34, wherein the drive or brake control function is executed by the apparatus 28 on the basis of these command signals. In particular, these command signals can be triggered by manual operation by the rail vehicle driver and/or automatically by a controller of the rail vehicle 10.

FIG. 3 shows a design of the apparatus 28. Components of the apparatus 28 are accommodated in a housing 50. The computer unit 32 which is, in particular, in the form of a multi-core processor having at least two processor units 32.1 and 32.2 is arranged in the housing 50 in particular. In this case, the processor units 32.1 and 32.2 are each formed by a different processor core. In an alternative design, the computer unit 32 can be formed by a single-core processor, wherein the processor units 32.1, 32.2 are each in the form of a logic processor unit.

The memory unit 30 has a plurality of memory areas 30.1, 30.2, 30.3 which are each provided for storing a different module. The areas 30.1, 30.2, 30.3 are provided, in particular, for storing a module AS of the drive control program (for example the above-described module for executing a traction power converter control function), a first module BS1 of the brake control program (for example the above-described module for executing a compressed-air brake valve control function) for a second module BS2 of the brake control program for executing a sliding-prevention function. The processor unit 32.1 is preferably allocated to the module AS of the drive program, while the processor unit 32.2 is preferably allocated to the module BS1 and/or BS2 of the brake control program. If the processor units 32.1, 32.2 are each in the form of a logic processor unit, they are produced, in particular, by a distribution of the processor resources of the individual-core processors, wherein one portion of these resources is allocated to the module AS of the drive program and another portion of the resources is allocated to the module BS1 and/or BS2 of the brake control program.

A voltage supply device 52—also called “power supply unit”—which supplies the electrical voltage to the components of the housing 50 is also arranged in the housing 50. The voltage supply device 52 is connected, in particular, to an on-board electrical system 53 of the rail vehicle 10.

Also provided is a communication module 54 which is provided for the purpose of establishing data communication between at least one component of the apparatus 28, in particular the computer unit 32 of said apparatus, and a rail vehicle control unit 56. Said data communication is performed, in particular, via a rail vehicle bus 58 to which the communication module 54 and the rail vehicle control unit 56 are connected. In the design under consideration, the communication module 54 is arranged in the housing 50. The communication module 54 is also called a “bus interface” by a person skilled in the art. The rail vehicle control unit 56 can be in the form of, in particular, a central controller. The rail vehicle control unit 56 and the above-described unit 51 can be identical to one another, partially integrally formed with one another or different from one another.

Only the above-mentioned modules AS, BS1 and BS2 of the drive control program and of the brake control program in the memory unit 30 are illustrated in the figure. However, a large proportion of modules, in particular all of the modules of the drive control program and of the brake control program, can be stored in the memory unit 30. The following designs and combinations thereof are possible for forming the memory unit 30: the memory areas of the memory unit 30 can be in the form of areas of the same physical memory or as separate physical memories; the memory unit 30 is arranged in the housing 50 in the design under consideration, wherein it is feasible in an alternative design for the at least one memory area of the memory unit 30 or the entire memory unit 30 to be arranged outside the housing 50.

FIG. 2 shows the interaction of the apparatus 28 with the drive device 16 and the constituent part of the brake device 34 which are associated with a specific pair of drive axles 14, that is to say a specific truck. The apparatus 28 is also provided for executing a brake control function for brake device components, not shown, which are associated with the running axles 15. In the design of the rail vehicle 10 with two drive devices 16 which is shown in FIG. 1, two train halves can be defined, wherein in each case one apparatus 28 is provided for each train half. In this case, the apparatuses 28 are each connected to the drive device 16 and the brake device components of the associated train half. In an alternative embodiment, the apparatus 28 can be designed as a central unit which is connected to all of the drive devices 16 and the entire brake device 34 of the rail vehicle 10 in terms of control. However, all other possible associations are also possible.

1-12. (canceled)

13. An apparatus for controlling a drive device and a brake device of a rail vehicle, the apparatus comprising:
a computer unit;
a memory unit connected to said computer unit;
said memory unit being configured to store therein at least one drive control module of a drive control program, the drive control module to be executed in order for at least one drive control function to be carried out by said computer unit; and
said memory unit being configured to store therein at least one brake control module of a brake control program, the brake control module to be executed in order for at least one brake control function for the brake device of the rail vehicle to be carried out by said computer unit.

14. The apparatus according to claim 13, wherein said computer unit is configured for operation with at least two processing units, wherein, in at least one operating phase, a different processor unit is in each case allocated to the drive control module of the driver control program and to the brake control module of the brake control program.

15. The apparatus according to claim 13, wherein the brake control module of the brake control program is configured for executing a compressed-air brake valve control function.

16. The apparatus according to claim 13, wherein the brake control module of the brake control program is configured for executing a sliding-prevention function.

17. The apparatus according to claim 13, wherein the drive control module of the drive control program is configured for executing a traction power converter control function.

18. The apparatus according to claim 13, which comprises a housing in which said computer unit and said memory unit are disposed.

19. The apparatus according to claim 18, which comprises a voltage supply device configured for supplying components in said housing.

20. The apparatus according to claim 13, which further comprises a communication module configured for establishing data communication with a rail vehicle control unit.

21. A rail vehicle, comprising at least a drive device, a brake device, and an apparatus according to claim 13.

22. A control method in a rail vehicle, the method comprising:
executing, with a computer unit, at least one drive control function for controlling a drive device of the rail vehicle; and
executing, with the computer unit, at least one brake control function for controlling a brake device of the rail vehicle.

23. The method according to claim 22, which comprises executing with the computer unit a compressed-air brake valve control function and a traction power converter control function.

24. The method according to claim 22, which comprises executing a sliding-prevention function by the computer unit.
